(19) United States
(12) Patent Application Publication
(10) Pub. No.: US 2025/0058698 A1
(43) Pub. Date: Feb. 20, 2025

(54) SUPPLEMENTAL ADAPTABLE ENHANCEMENT OF LIGHT FUNCTIONALITY FOR ADAPTABLE DRIVING BEAM HEADLAMPS

(71) Applicant: GM Global Technology Operations LLC, Detroit, MI (US)

(72) Inventors: Albert Ekladyous, Shelby Twp., MI (US); Michael K. Larsen, Warren, MI (US)

(21) Appl. No.: 18/449,913

(22) Filed: Aug. 15, 2023

(51) Int. Cl. B60Q 1/076; B60Q 1/00; B60Q 1/14

(52) U.S. Cl. CPC B60Q 1/076; B60Q 1/0076; B60Q 1/1415; B60Q 2200/30; B60Q 2300/054

(57) ABSTRACT

A vehicle includes a headlight. The headlight includes a light source configured to perform a first light function of projecting a beam of light at a first angle of declension from a horizontal line and a second light function of the headlight for projecting the beam of light at a second angle of declension from the horizontal line. The first light function is optically combined with the second light function.

### INTRODUCTION

The subject disclosure relates to headlights in a vehicle and, in particular, to a headlamp and method of use that enhances the functionality of an adaptable driving beam headlamp.

Adaptable driving beam (ADB) headlamps are being introduced into vehicles. In order to pass regulations testing, the ADB headlamps are directed at a downward angle from horizontal. However, maintaining light at this downward angle reduces the visibility provided by the ADB headlamp by as much as 70-80%. Accordingly, it is desirable to provide a method for providing visibility in a region not illuminated by the ADB due to its orientation.

### SUMMARY

In one exemplary embodiment, a method of operating a vehicle is disclosed. The method includes activating a first light function at a headlight of the vehicle to project a beam of light along a first direction and activating a second light function at the headlight to rotate the headlight to project the beam of light along a second direction, wherein the second light function is optically combined with the first light function.

In addition to one or more of the features described herein, the method further includes activating the second light function independently of activating the first light function.

In addition to one or more of the features described herein, the method further includes activating the second light function via a switch operated by a driver.

In addition to one or more of the features described herein, the headlight includes an Adaptive Driving Beam lamp (ADB lamp) for performing the first light function.

In addition to one or more of the features described herein, the ADB lamp includes an array of light emitting diodes.

In addition to one or more of the features described herein, the first direction is at a first angle of declension from a horizontal line, the second direction is at a second angle of declension from the horizontal line, and activating the second light function causes the headlight to rotate upward from the first angle of declension to the second angle of declension.

In addition to one or more of the features described herein, the second angle of declension is zero.

In another exemplary embodiment, a headlight for a vehicle is disclosed. The headlight includes a light source configured to perform a first light function of projecting a beam of light at a first angle of declension from a horizontal line and a second light function of the headlight for projecting the beam of light at a second angle of declension from the horizontal line, wherein the first light function is optically combined with the second light function.

In addition to one or more of the features described herein, the second light function is configured to be activated independently of the first light function.

In addition to one or more of the features described herein, the headlight further includes a switch configured to activate the second light function.

In addition to one or more of the features described herein, the light source is an Adaptive Driving Beam lamp (ADB lamp) disposed within a compartment of the headlight.

In addition to one or more of the features described herein, the ADB lamp includes an array of light emitting diodes.

In addition to one or more of the features described herein, the headlight is configured to rotate upward from the first angle of declension to the second angle of declension upon activating the second light function.

In addition to one or more of the features described herein, the second angle of declension is zero.

In yet another exemplary embodiment, a vehicle is disclosed. The vehicle includes a headlight. The headlight includes a light source configured to perform a first light function of projecting a beam of light at a first angle of declension from a horizontal line and a second light function of the headlight for projecting the beam of light at a second angle of declension from the horizontal line, wherein the first light function is optically combined with the second light function.

In addition to one or more of the features described herein, the second light function is configured to be activated independently of the first light function.

In addition to one or more of the features described herein, the vehicle further includes a switch configured to activate the second light function.

In addition to one or more of the features described herein, the light source is an Adaptive Driving Beam lamp (ADB lamp) disposed within a compartment of the headlight.

In addition to one or more of the features described herein, the ADB lamp includes an array of light emitting diodes.

In addition to one or more of the features described herein, the headlight is configured to rotate upward from the first angle of declension to the second angle of declension upon activating the second light function.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a side view of an external lighting system of the vehicle, in an illustrative embodiment;

FIG. 3 shows the vehicle of FIG. 1 with the headlight projecting a first beam of light and a second beam of light; and

FIG. 4 shows a dashboard display illustrating an option for activating a supplementary light beam of the headlight.

### DETAILED DESCRIPTION

The following description is merely exemplary in nature and is not intended to limit the present disclosure, its application or uses. It should be understood that throughout the drawings, corresponding reference numerals indicate like or corresponding parts and features.

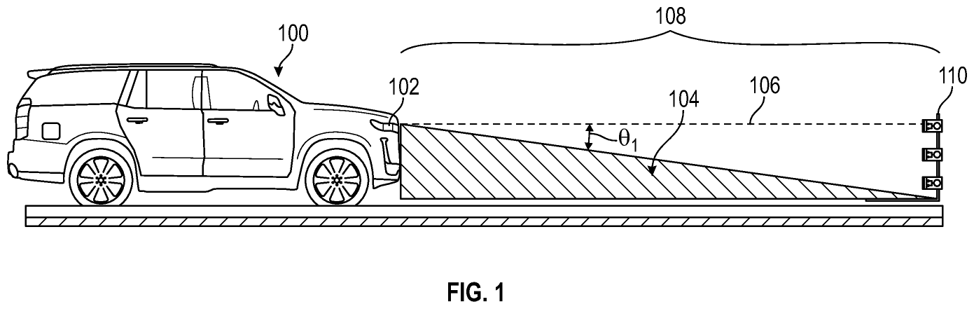

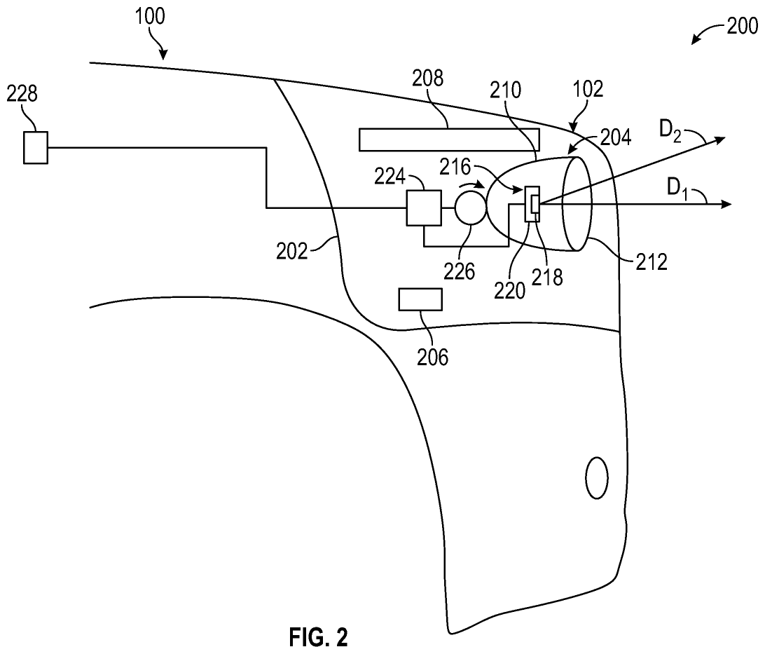

In accordance with an exemplary embodiment, FIG. 1 shows a vehicle 100. The vehicle includes an external lighting system 102 suitable for illuminating a region 104 in front of the vehicle. The external lighting system 102 can include various light sources including a headlight (204, FIG. 2). The headlight includes an Adaptable Driving Beam lamp (ADB lamp 216, FIG. 2) that is oriented to project a first beam of light at a first angle of declension θ₁ with respect to a horizontal line 106. The first beam of light illuminates a region 104, which extends over a range 108 in front of the vehicle 100. The orientation of the headlight (204, FIG. 2) at the first angle of declension θ₁ limits the range 108 of the region 104 and an object 110 at an end of the range is not immediately noticed.

FIG. 2 shows a side view 200 of the external lighting system 102 of the vehicle 100, in an illustrative embodiment. The external lighting system 102 includes a housing 202 that stores various light sources. The light sources can include, but are not limited to, a headlight 204, a daytime running lamp 206 (DRL), and a turn signal lamp 208. The headlight 204 includes a compartment 210 and a lens 212. A light source is disposed within the compartment 210. The light source can be an Adaptive Driving Beam lamp (ADB lamp 216) that includes an array 218 of light emitting diodes (LEDs) disposed on a chip 220. The LEDs can be independently activated and deactivated by the chip 220. The ADB lamp 216 can be used to perform two light functions. A first light function includes projecting a light beam along a first direction D₁. The first direction D₁ is at a downward angle (i.e., a first angle of declension) with respect to horizontal line 106 and is suitable for meeting testing requirements for the vehicle 100. The second light function is a supplementary light function in which the ADB lamp 216 projects the light beam along a second direction D₂. The second direction D₂ is at a second angle of declension θ₂ with respect to the horizontal line 106, where the second angle of declension is less than the first angle of declension (i.e., closer to horizontal). Thus, activating the second function includes rotating the ADB lamp 216 upward. The second angle of declension is a nominal angle for the headlight when driving the vehicle 100.

Since the ADB lamp 216 performs the first light function and the second light function using the same lens 212, these light functions are said to be optically combined. The supplementary light function can be activated and deactivated independently of the activation of ADB lamp 216. In other words, the ADB lamp 216 can be on while the supplementary light function is either on or off.

The supplementary light function is created by using an automatic levelling function of the headlight 204. Turning on the supplementary light function causes the headlight 204 to rotates upward. A processor 224 controls a motor 226 to rotate the headlight 204. In various embodiments, the processor 224 performs the second function by rotating the headlight 204 to align the ADB lamp 216 for projecting the beam of light along the second direction D₂. A switch 228 can be toggled to turn the supplementary light function on and/or off. The switch 228 sends a signal to the processor 224 which activates or deactivates the supplementary light function, thereby rotating the headlight, respectively, upward or downward.

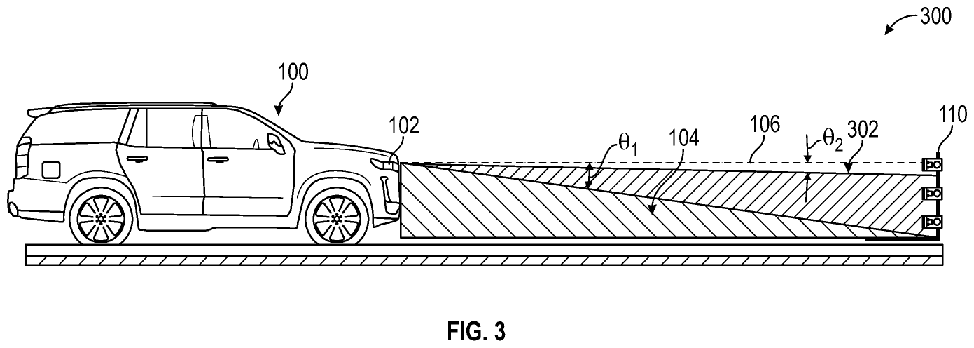

FIG. 3 shows the vehicle 100 of FIG. 1 with the headlight 204 projecting the beam of light along one of the first direction D₁ and the second direction D2. The first direction D₁ is at a first angle of declension θ₁ with respect to horizontal line 106 and the second direction D₂ is at a second angle of declension θ₂ with respect to horizontal line 106. The second angle of declension θ₂ is less than the first angle of declension θ₁. The second angle of declension θ₂ can be zero, in various embodiments. In other words, the second direction D₂ can be directed along, or parallel to, the horizontal line 106. Projecting the light along the second direction D₂ provides illumination of a second region 302 that is not illuminated when the light is projected along the first direction D₁. Illuminating the second region 302 provides the driver greater illumination of oncoming objects.

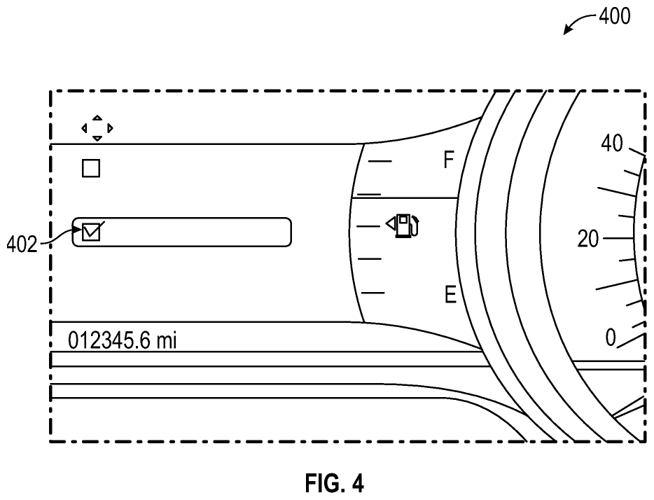

FIG. 4 shows a dashboard display 400 illustrating an option 402 for activating the supplementary light beam. The option 402 can be selected by a driver or operator of the vehicle. When this option 402 is selected, a switch signal is sent to the processor 224 to turn on the supplementary light function, thereby rotating the headlight 204 upward.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
activating a first light function at a headlight of the vehicle to project a beam of light along a first direction; and
activating a second light function at the headlight to rotate the headlight to project the beam of light along a second direction, wherein the second light function is optically combined with the first light function.

2. The method of claim 1, further comprising activating the second light function independently of activating the first light function.

3. The method of claim 2, further comprising activating the second light function via a switch operated by a driver.

4. The method of claim 1, wherein the headlight includes an Adaptive Driving Beam lamp (ADB lamp) for performing the first light function.

5. The method of claim 4, wherein the ADB lamp includes an array of light emitting diodes.

6. The method of claim 4, wherein the first direction is at a first angle of declension from a horizontal line, the second direction is at a second angle of declension from the horizontal line, and activating the second light function causes the headlight to rotate upward from the first angle of declension to the second angle of declension.

7. The method of claim 6, wherein the second angle of declension is zero.

8. A headlight for a vehicle, comprising:
a light source configured perform a first light function of projecting a beam of light at a first angle of declension from a horizontal line; and
a second light function of the headlight for projecting the beam of light at a second angle of declension from the horizontal line, wherein the first light function is optically combined with the second light function.

9. The headlight of claim 8, wherein the second light function is configured to be activated independently of the first light function.

10. The headlight of claim 9, further comprising a switch configured to activate the second light function.

11. The headlight of claim 8, wherein the light source is an Adaptive Driving Beam lamp (ADB lamp) disposed within a compartment of the headlight.

12. The headlight of claim 11, wherein the ADB lamp includes an array of light emitting diodes.

13. The headlight of claim 12, wherein the headlight is configured to rotate upward from the first angle of declension to the second angle of declension upon activating the second light function.

14. The headlight of claim 13, wherein the second angle of declension is zero.

15. A vehicle, comprising:
a headlight comprising:
a light source configured to perform a first light function of projecting a beam of light at a first angle of declension from a horizontal line; and
a second light function of the headlight for projecting the beam of light at a second angle of declension from the horizontal line, wherein the first light function is optically combined with the second light function.

16. The vehicle of claim 15, wherein the second light function is configured to be activated independently of the first light function.

17. The vehicle of claim 16, further comprising a switch configured to activate the second light function.

18. The vehicle of claim 15, wherein the light source is an Adaptive Driving Beam lamp (ADB lamp) disposed within a compartment of the headlight.

19. The vehicle of claim 18, wherein the ADB lamp includes an array of light emitting diodes.

20. The vehicle of claim 19, wherein the headlight is configured to rotate upward from the first angle of declension to the second angle of declension upon activating the second light function.
